(19) United States
(12) Patent Application Publication
(10) Pub. No.: US 2018/0373097 A1
(43) Pub. Date: Dec. 27, 2018

(54) LIGHT GUIDE PLATE, SURFACE LIGHT SOURCE DEVICE, DISPLAY DEVICE, AND ELECTRONIC DEVICE

(71) Applicant: OMRON Corporation, Kyoto-shi, KYOTO (JP)

(72) Inventors: Gouo KURATA, Kawanishi-shi (JP); Takafumi KUROKAWA, Sakado-shi (JP)

(73) Assignee: OMRON Corporation, Kyoto-shi, KYOTO (JP)

(21) Appl. No.: 15/781,700

(22) PCT Filed: Mar. 10, 2016
(86) PCT No.: PCT/JP2016/057633

§ 371 Date: Jun. 6, 2018

(30) Foreign Application Priority Data
Dec. 28, 2015 (JP) 2015-257405

(51) Int. Cl. G02F 1/1335; F21V 8/00; G02F 1/1333

(52) U.S. Cl. CPC G02F 1/133611; G02B 6/003; G02F 1/133305; G02B 6/009

(57) ABSTRACT

A light guide plate 10 includes: a first incidence surface 26; a first emission surface 21 intersecting with the first incidence surface 26 in a direction perpendicular thereto for emitting the light entering through the first incidence surface 26; a second incidence surface 27; and a second emission surface 23 intersecting with the second incidence surface 27 in a direction perpendicular thereto for emitting the light entering through the second incidence surface 27. The light guide plate 10 is planar. The first incidence surface 26 and the second incidence surface 27 are provided on side surfaces along directions perpendicular to each other; the first emission surface and the second emission surface are provided in different regions on the same plane of a first surface; and second protrusions 25 is provided on the second emission surface 23, which extends in a direction perpendicular to the second incidence surface 27.

### TECHNICAL FIELD

The present invention relates to a light guide plate, a surface light source device, a display device, and an electronic device.

### BACKGROUND

Recent years have brought smaller and thinner electronic devices. A liquid crystal device mounted on such electronic devices must have thinner and narrower edges to guarantee a larger display region without changing the surface area; at the same time the liquid crystal device must also provide better luminance uniformity. A backlight for a liquid crystal display device employs, for example, a sidelight type surface light source device (also referred to as edge lighting) using a light guide plate (also referred to as light guide) with a light emitting diode (LED) package that emits white light as a light source.

FIG. 1 is a schematic cross-sectional view of a conventional surface light source device 100 with a light guide plate. The surface light source device 100 includes a light guide plate 101 and a light source 120 arranged to face the incidence surface 102 of the light guide plate 101. The light emitted from the light source 120 enters the light guide plate 101 through the incidence surface 102 of the light guide plate 101 and travels inside the light guide plate 101 while repeatedly reflecting from the upper surface 103 and the lower surface 104 of the light guide plate 101. The light inside the light guide plate 101 impinges on dot patterns 105 provided on the lower surface 104 of the light guide plate 101 and is reflected and diffused therefrom so that the incidence angle of the light incident on the upper surface 103 of the light guide plate 101 changes. When the light incident on the upper surface 103 of the light guide plate 101 is incident at an incidence angle less than the critical angle, the light exits from the upper surface 103 of the light guide plate 101.

FIG. 2 is a schematic cross-sectional view illustrating the entire conventional surface light source device 100. As shown in FIG. 2, the light source 120 is mounted on a flexible substrate 108. Optical sheets 109 are arranged near the upper surface 103 of the light guide plate 101 and a reflective sheet 110 is arranged near the lower surface 104 of the light guide plate 101. A frame 107, the optical sheets 109, and the light source 120 are secured to a fixing part (not shown) arranged on the lower surface of a flexible substrate 108 or the like. A light shielding double-sided tape 111 is formed into a frame shape, thereby preventing light from leaking outside the surface light source device 100. Further, light leaking from an opposite incidence surface 106 of the light guide plate 101 is prevented from leaking outside the surface light source device 100 with the leaked light reentering the light guide plate 101 after reflecting from the frame 107 or being absorbed by the frame 107.

A dual-screen surface light source device 200 is known, which includes a main screen 200a and a secondary screen 200b on a liquid crystal screen as shown in FIG. 3(a) (for example, see Japanese Patent No. 4238806 and Japanese Patent Publication No. 2011-33882); the secondary screen 200b is smaller than the main screen 200a.

### Technical Problem

In a typical dual-screen surface light source device 200 as shown in FIG. 3(b), the light source for the main screen 200a is an LED 220 located to the main screen 200a along the end face thereof opposite the secondary screen 200b. Whereas, the secondary screen 200b has an LED 230 provided on an end face along the transverse direction of the secondary screen 200b. As such, the LED 230 for the secondary screen 200b and the LED 220 for the main screen 200a are provided on the end faces of the surface light source device 200 along directions perpendicular to each other.

FIG. 3(c) depicts the luminance distribution when both the LED 220 for the main screen and the LED 230 for the secondary screen are turned on in the dual-screen surface light source device 200. As can be seen from FIG. 3(c), a portion where the LED 230 for the secondary screen is arranged toward the main screen 200a exhibits uneven luminance along the diagonal. FIG. 3(d) depicts a luminance distribution when the LED 220 for the main screen is turned off and the LED 230 for the secondary screen is turned on in the dual-screen surface light source device 200. As can also be seen from FIG. 3(d), the light from the LED 230 for the secondary screen leaks from the secondary screen 200b toward the main screen 200a and diffuses diagonally, which appears to cause the unevenness in luminance.

In light of the foregoing problems embodiments of the present invention provides a technology for preventing the light from the light source of a secondary screen in a dual-screen surface light source device from leaking toward the main screen, thereby controlling uneven luminance in the main screen.

### SUMMARY

To address the above-described problems, embodiments of the present invention provide a light guide plate including: a first incidence surface whereon light from a first light source is incident;

a first emission surface intersecting with the first incidence surface in a direction substantially perpendicular thereto for emitting the light entering through the first incidence surface;

a second incidence surface whereon light from a second light source is incident; and

a second emission surface intersecting with the second incidence surface in a direction substantially perpendicular thereto for emitting the light entering through the second incidence surface, wherein the light guide plate is substantially planar;

the first incidence surface and the second incidence surface are provided on side surfaces along directions substantially perpendicular to each other;

the first emission surface and the second emission surface are provided in different regions in the same plane on a first surface; and

a pattern is formed extending in a direction substantially perpendicular to the second incidence surface on at least one of the second emission surface and a region corresponding to the second emission surface on a second surface opposite the first surface.

Here, the pattern as described above includes a pattern discretely arranged in a direction substantially perpendicular to the second incidence surface as well as the pattern continuously formed extending in a direction substantially perpendicular to the second incidence surface.

With this configuration, the light from the second light source entering through the second incidence surface is guided in a direction perpendicular to the second incidence surface by the pattern formed extending in a direction substantially perpendicular to the second incidence surface; the light from the second light source tends not to diffuse in a direction parallel to the second incidence surface. As a result, it is possible to minimize the amount of light leaking out to the first emission surface after entering through the second incidence surface. Thus, it is possible to improve the uniformity of the light intensity distribution and reduce the unevenness in the light intensity over the entire light guide plate.

According to the embodiments of present invention the pattern is made up of a plurality of second protrusions extending in a direction substantially perpendicular to the second incidence surface. According to this configuration, a so-called lenticular portion can be formed on at least one of the second emission surface and a region corresponding to the second emission surface on the second surface opposite the first surface, and thus it is possible to minimize further reliably the amount of light entering through the second incidence surface that leaks into the first emission surface. Here, the plurality of protrusions represents a structure having a plurality of linearly aligned protrusions, but this also represents a structure having a plurality of linearly aligned recesses.

Further, according to embodiments of the present invention, the second incidence surface is provided in a part of a region opposite the first incidence surface on a side surface where the second incidence surface is provided;

the second emission surface is provided on the first surface whereon the second emission surface and the first emission surface are provided in a part of the region opposite the first incidence surface;
the first emission surface is provided in a region on the first surface excluding the second emission surface; and
a plurality of first protrusions is provided continuously from the plurality of second protrusions extending in a direction substantially perpendicular to the second incidence surface in a portion near the second protrusions on the first emission surface and the region corresponding to the first emission surface on a rear surface opposite the planar surface.

With this configuration, some light from the first light source entering through the first incidence surface is exits outside via the first protrusions, thereby reducing the amount of light directly reaching the second protrusions. Thus, this prevents the light from the first light source entering through the first incidence surface from being viewed as a bright line, since the bright light is due to light reaching the second protrusions unobstructed and exiting therefrom.

Further, according to embodiments of the present invention, the percentage area of the first protrusions per unit area may decrease with distance from the second protrusions in a portion where the plurality of first protrusions is provided.

With this configuration, the light from the first light source entering through the first incidence surface may be gradually emitted outside by the first protrusions before reaching the second protrusions. Thus, this more reliably prevents the light from the first light source entering through the first incidence surface from being viewed as a bright line, since the bright light is due to light directly reaching the second protrusions and exiting therefrom. Thereby, it is possible to improve the uniformity of luminance distribution over the entire light guide plate.

Further, according to embodiments of the present invention, a ratio of height to width of the first protrusions may decrease with distance from the second protrusions in a portion where the plurality of first protrusions is provided. Further, the shape of the first protrusions may gradually changes with distance from the second protrusions in a portion where the plurality of first protrusions is provided. With these configurations, the light from the first light source entering through the first incidence surface may be emitted outside gradually by the first protrusions before reaching the second protrusions. This further reliably prevents the light from the first light source entering through the first incidence surface from being viewed as a bright line, since the bright line is due to light directly reaching the second protrusions and exiting therefrom. Thereby, it is possible to improve the uniformity of luminance distribution over the entire light guide plate.

Further, according embodiments of to the present invention, the first protrusions and the second protrusions may have substantially the same shape at a boundary portion therebetween. According to this configuration, the light from the first light source entering through the first incidence surface can be emitted continuously over the first protrusions and the second protrusions in the boundary portion between the first protrusions and the second protrusions. This further reliably prevents the light from the first light source entering through the first incidence surface from being viewed as a bright line, since the bright light is due to light directly reaching the second protrusions and exiting therefrom. Thereby, it is possible to further improve the uniformity of the luminance distribution over the entire light guide plate.

Further, according to embodiments of the present invention, at least a portion of the surface whereon the plurality of the first protrusions are not formed may be made up of a mirror surface in a region where the first protrusions are provided among the first emission surface and the region corresponding to the first emission surface on the second surface opposite the first surface.

Further, according to embodiments of the present invention, third protrusions extending in a direction substantially perpendicular to the first incidence surface are provided in a portion having no first protrusions in the region including the plurality of first protrusions among the first emission surface and the region corresponding to the second emission surface on the second surface; and the percentage area of the third protrusions per unit area may decrease with distance from the first light incident surface. According to this configuration, the third protrusions can efficiently guide the light from the first light source entering through the first incidence surface to the first protrusions, thereby improving the luminance on the first emission surface. Further, the third protrusions decrease in size with distance from the first incidence surface, and thus it is possible to reliably improve the luminance uniformity of the first emission surface.

According to embodiments of the present invention, the cross-sectional shape of the second protrusions viewed along the extending direction may be an arc, a convex curve, a triangle, a rectangle or larger-sided polygon.

Further, according to embodiments of the present invention, when viewing a cross section of the along the extending direction thereof in a section closer to the first incidence surface than the center of the part whereon the second protrusions are provided, an acute angle between a line normal to the first incidence surface and a slope of the second protrusions oriented toward the first incidence surface when viewed from the inside of the light guide plate may increase as distance from the first incidence surface increases.

According to this configuration, it is possible to increase the likelihood that the light is totally reflected at the second protrusions that are closer to the first incidence surface and to decrease the likelihood that the light is totally reflected at the second protrusions that are distant from the first light incidence surface when the light from the first light source entering through the first emission surface reaches the second protrusions. This configuration, more reliably prevents light from the first light source entering through the first incidence surface from being viewed as a bright line, since the bright line is due to light directly reaching the second protrusions and exiting all at once therefrom. Thereby, it is possible to improve the uniformity of the luminance distribution over the entire light guide plate.

Further according to embodiments of the present invention, when viewing a cross section of the along the extending direction thereof in a section closer to the first incidence surface than the center of the part whereon the second protrusions are provided, an acute angle between a line normal to the first incidence surface and a slope of the second protrusions oriented toward the first incidence surface when viewed from the inside of the light guide plate may become greater than an acute angle between a line normal to the first incidence surface and a slope of the second protrusions oriented away from the first incidence surface when viewed from the inside of the light guide plate with distance from the first incidence surface. This configuration prevents light from the first light source entering through the first incidence surface from being viewed as a bright line, since the bright line is due to light directly reaching the second protrusions and exiting therefrom all at once. Thereby, it is possible to improve the uniformity of the luminance distribution over the entire light guide plate.

Further, according to embodiments of the present invention, the ratio of height to width of the second protrusions may be greater than or equal to 0.067. Here, it has been found that the amount of light leaking toward the first emission surface from light from the second light source entering through the second incidence surface may be reduced by the second protrusions having the ratio of height to width greater than or equal to 0.067. Thus, setting the ratio of height to width of the second protrusions to a value greater than or equal to 0.067 minimizes the amount of light entering through the second incidence surface and leaking toward the first emission surface. Thus, it is possible to improve the uniformity of luminance distribution over the entire light guide plate, thereby reducing unevenness in the light intensity.

Further, according to embodiments of the present invention, the ratio of height to width of the second protrusions may be greater than or equal to 0.158. Here, it has been found that the amount of light leaking toward the first emission surface from light from the second light source entering through the second incidence surface may be reduced to less than half by the second protrusions having the ratio of height to width greater than or equal to 0.158. Thus, setting the ratio of height to width of the second protrusions to a value greater than or equal to 0.158 more reliably minimizes the amount of light entering through the second incidence surface and leaking toward the first emission surface.

Thus, it is possible to improve the uniformity of the luminance distribution over the entire light guide plate, thereby reducing the unevenness in the light intensity.

Further, according to embodiments of the present invention, the width of the second emission surface along a direction parallel to the first incidence surface may be narrower than the width of the first emission surface along a direction parallel to the first incidence surface, and the end face whereon the second incidence surface is provided may be recessed relative to the end face adjacent to the second incidence surface near the first emission surface.

According to this configuration, the end face whereon the second incidence surface is provided is recessed relative to the end face adjacent to the second incidence surface near the first emission surface, and thus the second light source may be stored in a space created by the recess. Other components such as a camera may also be stored in the space. As a result, it is possible to improve the efficient use of space, make frame parts compact, and increase the percentage area of the screen in the device.

Further according to embodiments of the present invention, the end face whereon the second incidence surface is provided is recessed relative to the end face adjacent to the second incidence surface near the first emission surface and creates a step. The step may be provided with a light shielding part configured to prevent the light from the second light source from entering inside the light guide plate through the step. Thus, the light shielding part may minimize the light from the second light source that enters the light guide plate directly through the step. As a result, it is possible to improve the luminance uniformity over the entire light guide plate, thereby reducing unevenness in luminance. The light shielding part may be created by securing a light shielding material such as a seal to the step or by applying light shielding paint thereto.

Further according to embodiments of the present invention, the second emission surface may be thinner than the first emission surface. The second emission surface thus proportionally thicker at the second protrusions in the light guide plate; this more efficiently minimizes the amount of light that leaks toward the first emission surface after entering through the second incidence surface. Thus, it is possible to improve the uniformity of luminance distribution over the entire light guide plate, thereby reducing unevenness in the light intensity.

Further according to embodiments of the present invention, a boundary portion between the first emission surface and the second emission surface may be thinner than other regions. This prevents the light entering through the second incidence surface and passing through the light guide plate near the second emission surface from leaking out toward the first emission surface. Thus, it is possible to improve the uniformity of the luminance distribution over the entire light guide plate, thereby reducing the unevenness in luminance.

Further according to embodiments of the present invention, dot patterns for scattering the light guided through the light guide plate may be provided on at least one of the first surface whereon the first emission surface and the second emission surface are provided and the surface opposite the first surface. Thereby, the first emission surface and the second emission surface can emit light more efficiently.

Further according to embodiments of the present invention, dot patterns are provided on at least one of the first emission surface and the region corresponding to the first emission surface on the second surface opposite the first surface, and in plan view the dot patterns are at the maximum per unit area at a prescribed portion from the first incidence surface to a boundary portion between the first emission surface and the second emission surface. According to this configuration, the first emission surface emits light from the first light source entering through the first incidence surface more efficiently. The configuration thus prevents light from the first light source entering through the first incidence surface from being viewed as a bright line, since the bright line is due to light directly reaching the second protrusions and exiting therefrom all at once. Thereby, it is possible to improve the uniformity of the luminance distribution over the entire light guide plate. The above-described prescribed portion may be an arbitrary portion in the light guide plate from the first emission surface to the boundary portion between the first emission surface and the second emission surface, which may be obtained theoretically or experimentally so that luminance distribution over the entire light guide plate becomes more uniform.

Further according to embodiments of the present invention, the second protrusions may be provided periodically along the extending direction. According to this configuration, the second protrusions guide light from the second light source entering through the second incidence surface in the direction the second protrusions extend; the second emission surface also emits this light more efficiently because the periodic second protrusions may serve as dot patterns. As a result, the light from the second light source entering through the second incidence surface is more reliably prevented from leaking out toward the first emission surface, while improving the luminance uniformity of in the second emission surface and suppressing uneven luminance.

According to embodiments of the present invention, the means for solving the above described problems may be combined as appropriate.

### Effects

According to embodiments of the present invention, the light from a light source of a secondary screen is prevented from leaking out toward a main screen in a dual screen surface light source device, thereby controlling uneven luminance on the main screen.

### BRIEF DESCRIPTION OF THE DRAWINGS

FIG. 1 is a schematic cross-sectional view of a conventional surface light source device near a light guide plate;

FIG. 2 is a cross-sectional view of a conventional surface light source device;

FIG. 3 illustrates the luminance distribution of a dual-screen surface light source device;

FIG. 4 is an exploded perspective view of a liquid crystal display device according to an embodiment;

FIG. 5 is an exploded perspective view of a surface light source device according to an embodiment;

FIG. 6 is a perspective view of a light guide plate according to a first embodiment;

FIG. 7 is a view illustrating the effect of improved luminance distribution due to the structure of a light guide plate according to the first embodiment;

FIG. 8 is a graph illustrating the relationship between the size of a prism and the effect of improved luminance distribution according to the first embodiment;

FIG. 9 is a view illustrating the variation of the cross-sectional shape of a prism according to the first embodiment;

FIG. 10 is a perspective view illustrating a light guide plate according to a second embodiment;

FIG. 11 is a perspective view illustrating a light guide plate according to a third embodiment;

FIG. 12 is a perspective view illustrating a light guide plate according to a fourth embodiment and a view illustrating the effects of the structure;

FIG. 13 is a view illustrating the variation of the cross-sectional shape of a prism according to the fourth embodiment;

FIG. 14 is a perspective view illustrating a light guide plate according to a fifth embodiment;

FIG. 15 is a perspective view illustrating a light guide plate according to a sixth embodiment;

FIG. 16 is a perspective view illustrating a light guide plate according to a seventh embodiment; and

FIG. 17 is a perspective view illustrating another aspect of the light guide plate according to the seventh embodiment.

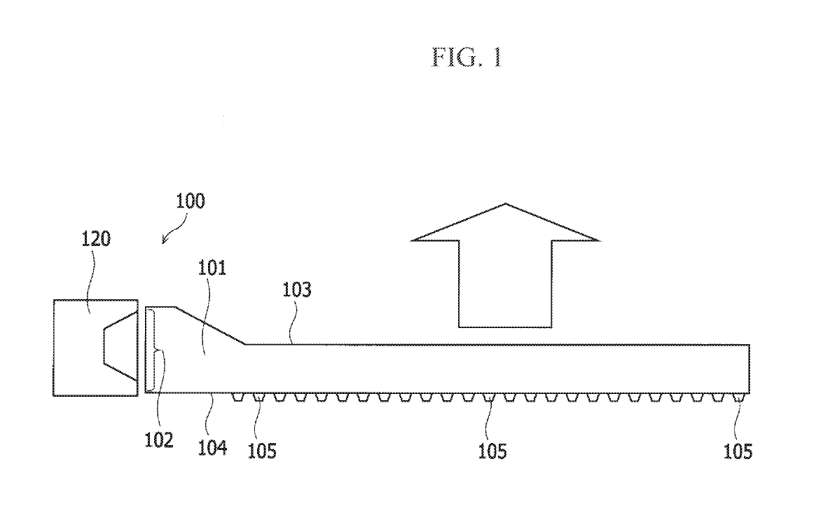

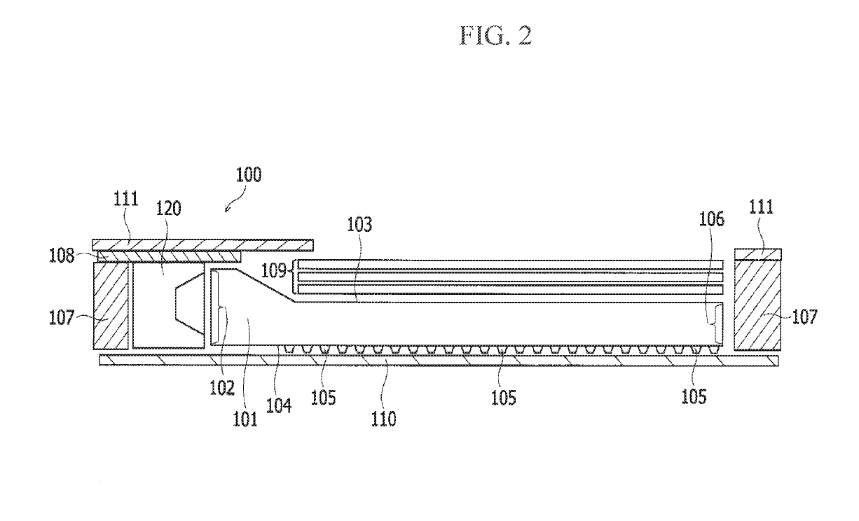

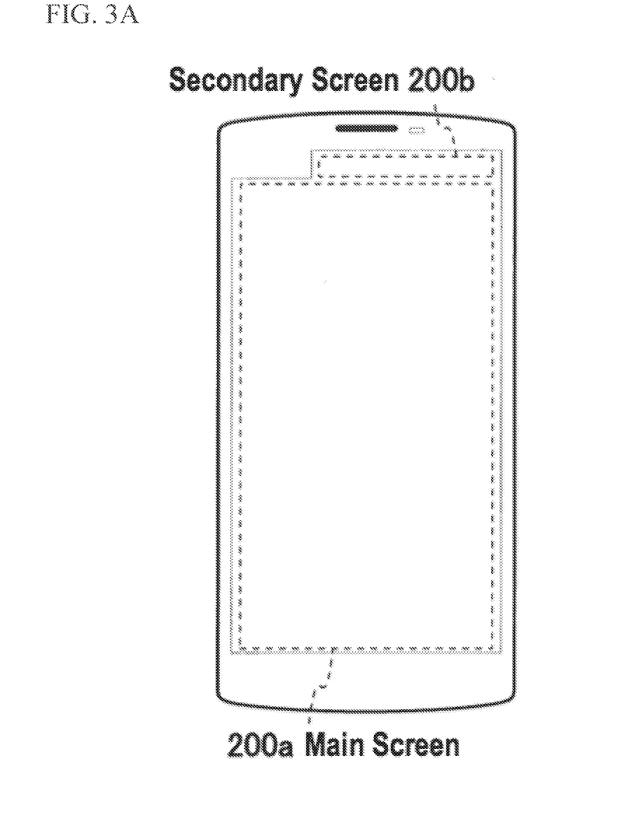

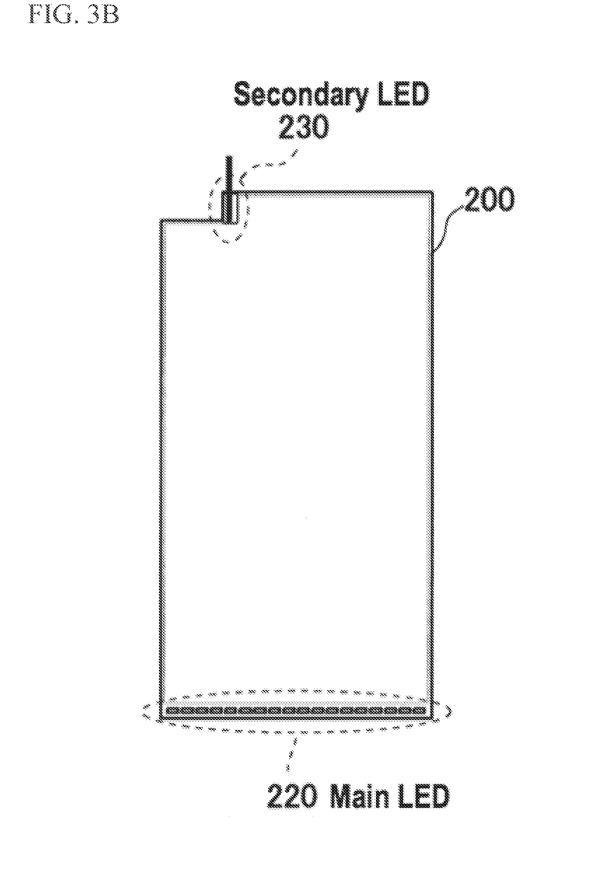

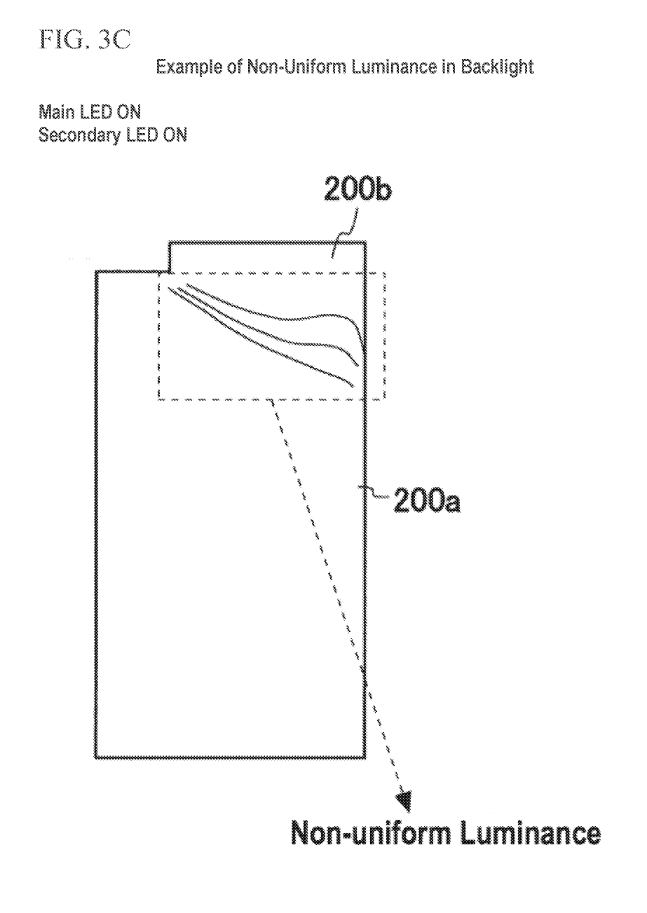

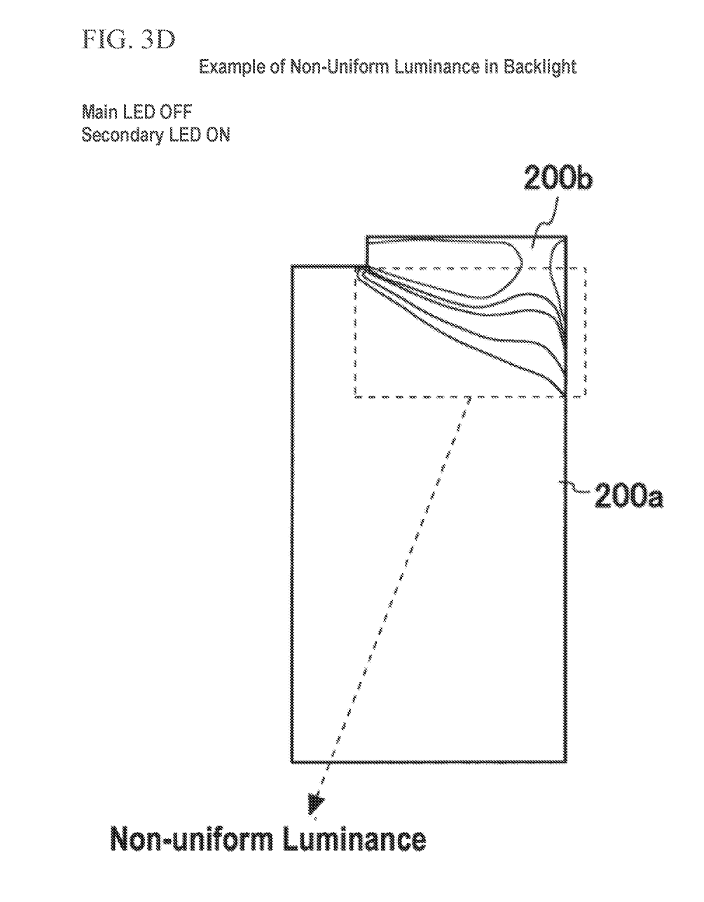

### DETAILED DESCRIPTION

Hereinafter, the present invention is described by way of embodiments with reference to the drawings; however, the following embodiments are merely examples of putting the present invention into practice and the claimed invention is not limited thereto.

In the following embodiments, “a display device” is described as a liquid crystal display device; “a surface light source device” is described as a backlight for the liquid crystal display device; “a light source” is described as an LED package. Further, “the surface light source device” may be adopted in ways other than as the backlight, such as a front light arranged at the front of a display device configured from a liquid crystal panel or electronic paper.

### First Embodiment

### (Configuration of the Liquid Crystal Display Device)

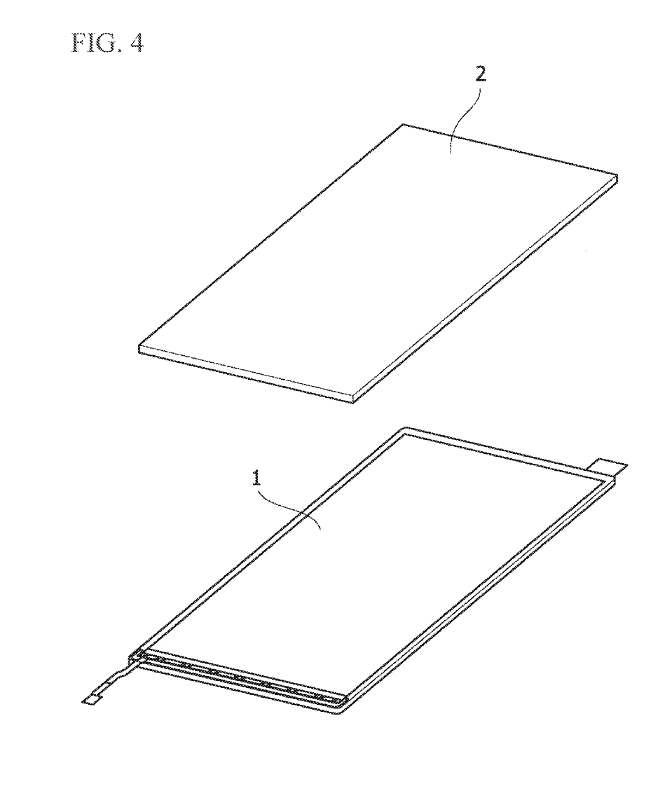

FIG. 4 is a perspective view illustrating the structure of a liquid crystal display device according to a first embodiment. As shown in FIG. 4, the liquid crystal display device according to this embodiment includes a surface light source device 1 arranged as a backlight and a liquid crystal panel 2 receiving the light emitted from the surface light source device 1. A voltage is applied to a liquid crystal sealed between glass plates to thus increase or decrease the transmittance of light therethrough. Hereby, the liquid crystal panel 2 can display an image. The liquid crystal display devices described with other later-described embodiments are similarly configured. Hereinafter, the surface light source device 1 is described with the surface near the liquid crystal panel 2 as the upper surface and with a rear surface opposite thereto as the lower surface.

(Configuration of the Surface Light Source Device 1)

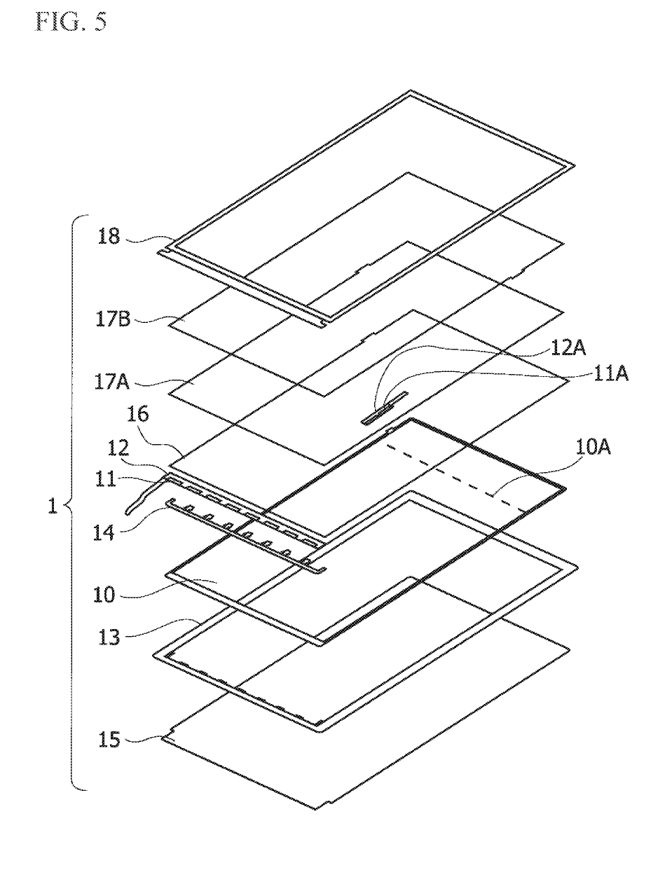

FIG. 5 is a perspective view illustrating the structure of a surface light source device 1 according to the first embodiment. The surface light source device 1 according to this embodiment includes a light guide plate 10, a light source 11, a flexible substrate 12 (hereinafter also referred to as an “FPC”), a frame 13, and a fixing part 14. Further, the surface light source device 1 includes a reflective sheet 15 arranged near the lower surface of the light guide plate 10. The surface light source device 1 also includes a diffusion sheet 16, prism sheets 17A, 17B, and a light shielding double-sided tape 18 near the upper surface of the light guide plate 10 laminated in that order.

The light guide plate 10 has substantially flat plate made up of a translucent material such as a polycarbonate resin and a polymethyl methacrylate resin. The upper surface of the light guide plate 10 forms an emission surface for emitting light. The light guide plate 10 guides the light entering therein from the light source 11 toward the emission surface, to thereby cause the entire emission surface to emit light uniformly. According to this embodiment, the light guide plate 10 includes a dual screen with a main screen having an emission surface and a secondary screen having an emission surface; the emission surfaces of the main and secondary screens are depicted separated by a broken line 10A in the drawing.

The light source 11 for the main screen (hereinafter, simply referred to as a main light source 11) emits white light from a fluorescent part. The main light source 11 is, for example, an LED package, but light sources other than an LED package may also be used. The main light source 11 is an LED chip made up of a light-emitting element sealed in a translucent resin (resin layer) containing a fluorescent material. The main light source 11 is driven by power from the FPC 12. The LED light source that emits a color other than white may be used. The FPC 12 is a printed circuit board configured by wiring a conductive foil on a base material made up of a flexible insulation film and bonding a coverlay as a protective insulation film onto the surface. A plurality of main light sources 11 is mounted on the FPC 12 in a row with a fixed space between the main light sources 11.

This embodiment is provided with a light source 11A for the secondary screen (hereinafter simply referred to as a secondary light source 11A). The structure of the secondary light source 11A is the same as the structure of the main light source 11 and thus is not detailed here. The secondary light source 11A is driven by power from the FPC 12A. The FPC 12A has a single or a plurality of secondary light sources 11A mounted thereon. Here, the main light source 11 corresponds to a first light source and the secondary light source 11A corresponds to a second light source.

The frame 13 has an opening and is made up of a four-sided frame shaped material (and is one example of “a frame body”). The frame 13 is molded from a polycarbonate resin containing titanium oxide and the like. The light guide plate 10 is fitted to the frame 13 so that the inner periphery of the frame 13 surrounds the side surfaces forming the outer periphery of the light guide plate 10. The frame 13 has a high reflectance, and thus reflects light to prevent the light in the light guide plate 10 from leaking out from the outer periphery of the light guide plate 10. The frame 13, for example, has a reflectance of 96% for white light. The fixing part 14 is arranged under the lower surface of the FPC 12, to secure the FPC 12, the frame 13, and the light guide plate 10. The fixing part 14 is, for example, a double-sided adhesive tape where both the upper and lower surfaces are adhesive.

The reflective sheet 15 is a smooth sheet made up of a high reflectance film having a multi-layer film structure, a high reflectance white resin sheet, or a metal foil, and reflects light to prevent the light inside the light guide plate 10 from leaking out from the lower surface of the light guide plate 10. The diffusion sheet 16 is a semi-transparent resin film, and diffuses the light emitted from the emission surface of the light guide plate 10 to thereby spread the directional characteristics of light. The prism sheets 17A and 17B are transparent resin films having fine triangular-prism patterns formed on the upper surfaces thereof; the prism sheets 17A and 17B collect the light diffused by the diffusion sheet 16 to thereby increase the luminance when the surface light source device 1 is viewed from the upper surface. The light shielding double-sided tape 18 is a black adhesive tape with adhesive upper and lower surfaces. The light shielding double-sided tape 18 has a frame-like shape, thereby prevents light from leaking therefrom.

(Configuration of the Light Guide Plate 10)

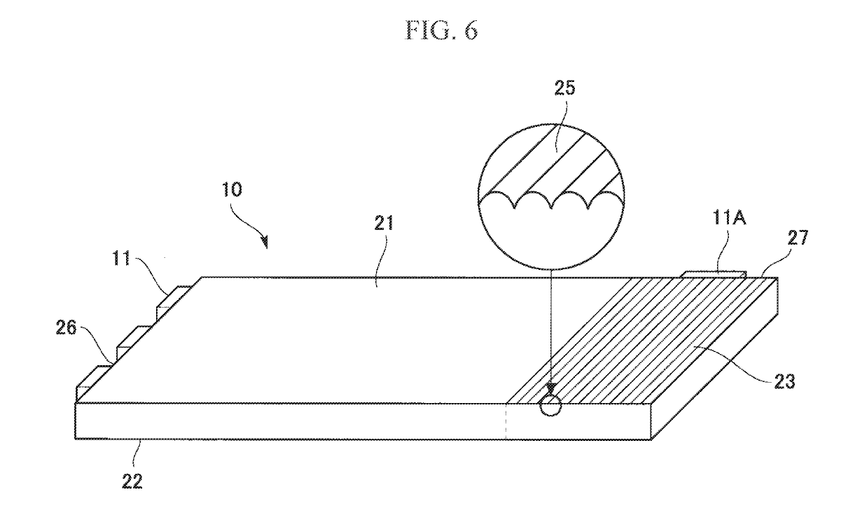

FIG. 6 is a perspective view illustrating a specific structure of the light guide plate 10 according to this embodiment. The light guide plate 10 is a flat plate having a substantially rectangular shape in plan view as previously described. The light guide plate 10 has a main incidence surface 26 whereon the light emitted from the main light source 11 is incident, and a main emission surface 21 wherefrom the light entering through the main incidence surface 26 is emitted. The light guide plate 10 also has a secondary incidence surface 27 whereon the light emitted from the secondary light source 11A is incident, and a secondary emission surface 23 wherefrom the light entering through the secondary incidence surface 27 is emitted. Here, the main incidence surface 26 is arranged on a short-side side surface of the light guide plate 10, and the secondary incidence surface 27 is provided along a long-side side surface of the light guide plate 10 in a region opposite the main incidence surface 26. The main incidence surface 26 corresponds to a first incidence surface. The main emission surface 21 corresponds to a first emission surface. The secondary incidence surface 27 corresponds to a second incidence surface. The secondary emission surface 23 corresponds to a second emission surface.

Although the sizes of the main emission surface 21 and the secondary emission surface are determined by the specification of the surface light source device 1, according to this embodiment, the secondary emission surface 23 is formed in a part of a region opposite the main incidence surface 26 of the light guide plate 10, and the region other than the secondary emission surface 23 forms the main incidence surface 21. Both the length of the main emission surface 21 and the secondary emission surface 23 in a direction perpendicular to the secondary incidence surface 27 are equal to the width of the short side of the light guide plate 10. Further, dot patterns (not shown) are discretely provided on a rear surface 22 opposite the main emission surface 21 and the secondary emission surface 23 of the light guide plate 10 for scattering the light reaching the rear surface 22.

The main emission surface 21 of the light guide plate 10 according to this embodiment is a mirror surface. Light emitted from the main light source 11 enters the light guide plate 10 through the main incidence surface 26 of the light guide plate 10, and is guided inside the light guide plate 10 to the opposite side of the main incidence surface 26 while repeatedly reflecting between the main emission surface 21 and the rear surface 22 of the light guide plate 10. The light inside the light guide plate 10 is subjected to diffuse reflection at the dot patterns (not shown) provided on the rear surface 22 so that the incidence angle of light incident on the main emission surface 21 changes. When the incidence angle of the light incident on the main emission surface 21 is less than a critical angle, the light exits to the outside from the main emission surface 21.

Further, a lenticular portion 25 is provided on the secondary emission surface 23 of the light guide plate 10. The lenticular portion 25 is constituted by a plurality of protrusions extending in a direction perpendicular to the secondary emission surface 27 of the light guide plate 10. Each protrusion is described as a prism hereinafter. The cross-section of each prism of the lenticular portion 25 is a semicircular arc. The lenticular portion 25 provided on the secondary emission surface 23 of the light guide plate 10 prevents light from the secondary light source 11A entering the light guide plate 10 via the secondary incidence surface 27 from diffusing in a direction perpendicular to the direction the lenticular portion 25 extends; this prevents light from the secondary light source 11A entering the light guide plate 10 via the secondary incidence surface 27 from leaking to the main emission surface 21, and exiting via the main emission surface 21.

This may improve the uniformity of luminance of the light emitted from the main emission surface 21 and the secondary emission surface 23 of the light guide plate 10. The plurality of prisms in the lenticular portion 25 are arranged parallel to each other on the secondary emission surface 23. The plurality of prisms in the lenticular portion 25 may be arranged at regular intervals, or may be arranged without intervals. The pitch of each prism in the lenticular portion 25 may be, for example, between 70 μm and 90 μm, inclusive, but is not limited to these values. The lenticular portion 25 may be integrally molded with a light guide plate 10 that is manufactured by injection molding. In this embodiment, the plurality of prisms in the lenticular portion 25 corresponds to second protrusions or patterns.

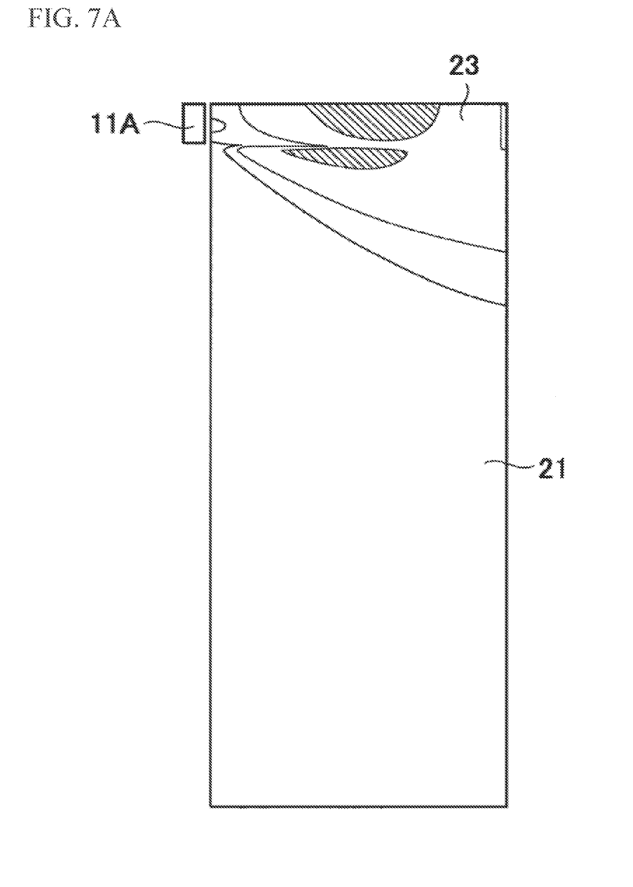

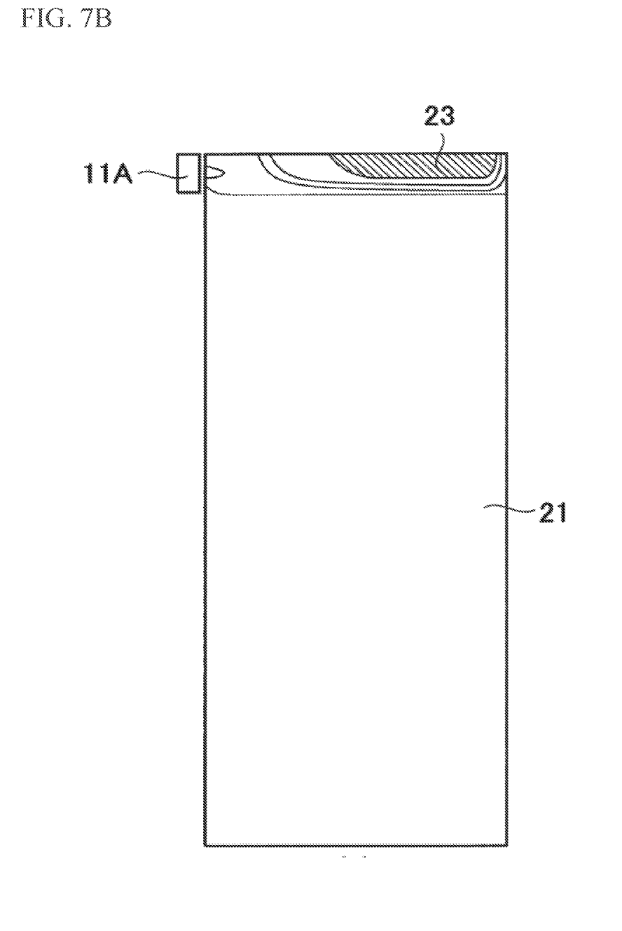

FIG. 7 illustrates the effect due to the structure of the first embodiment according to the present invention. FIG. 7(a) shows the luminance distribution of the light emitted from the light guide plate 10 when only the secondary light source 11A is turned on and the lenticular portion 25 is not provided on the secondary emission surface 23. FIG. 7(b) shows the luminance distribution of the light emitted from the light guide plate 10 when only the secondary light source 11A is turned on and the lenticular portion 25 is provided on the secondary emission surface 23.

As can be understood from comparing FIG. 7(a) and FIG. 7(b), light from the secondary light source 11A entering through the secondary incidence surface 27 does not leak to the main emission surface 21 and thus exit from the main emission surface 21 when the lenticular portion 25 is provided on the secondary emission surface 23. Specifically, FIG. 7(a) shows that the luminance in the secondary emission surface 23 is equivalent to the luminance of the light leaking to the main emission surface 21. Whereas, FIG. 7(b) shows that the luminance on the secondary emission surface 23 is two times the luminance depicted in FIG. 7(a), and the luminance of the light leaking to the main emission surface 21 is reduced to one-ninth of the luminance depicted in FIG. 7(a).

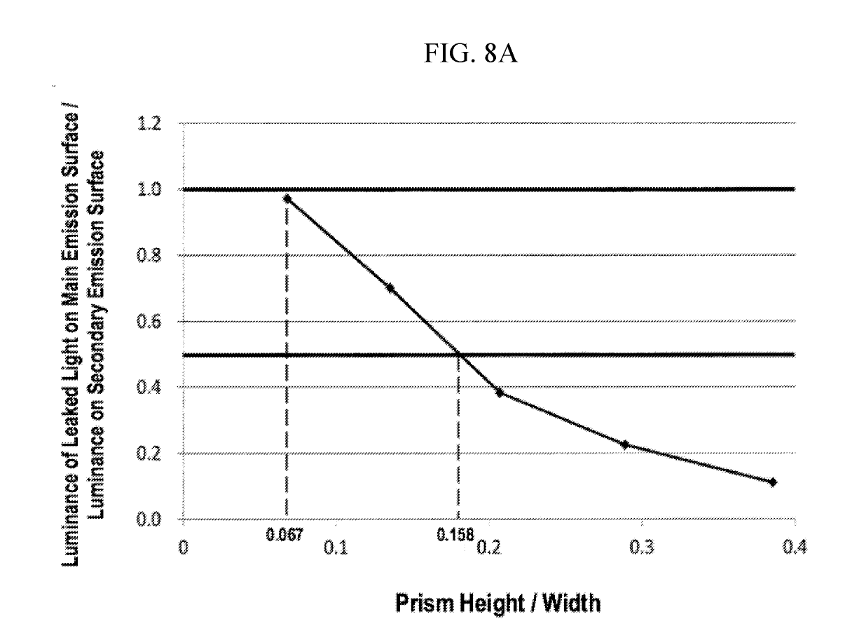

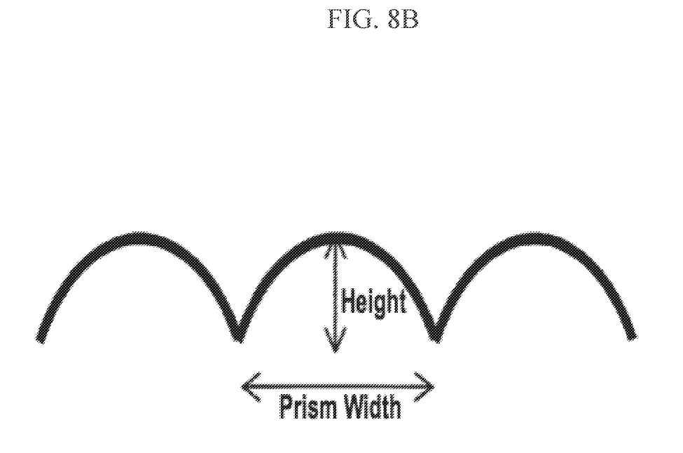

FIG. 8 shows a graph illustrating relationships between the shape of each prism in the lenticular portion 25 and the effect. The horizontal axis of the graph shown in FIG. 8(a) represents ratios of height to width (height/width) of a prism in the lenticular portion 25 as shown in FIG. 8(b). The vertical axis represents the luminance of the light leaked to the main emission surface 21 with respect to the luminance on the secondary emission surface 23 (luminance of light leaked to main emission surface/luminance on secondary emission surface). It can be understood from FIG. 8 that the luminance on the secondary emission surface can be set higher than the luminance of the light leaked to the main emission surface by setting the height-to-width ratio of the prism to 0.067 or greater. It can also be understood that the luminance of the light leaked to the main emission surface can be reduced to no more than half the luminance on the secondary emission surface by setting the height-to-width ratio of the prism to 0.158 or greater.

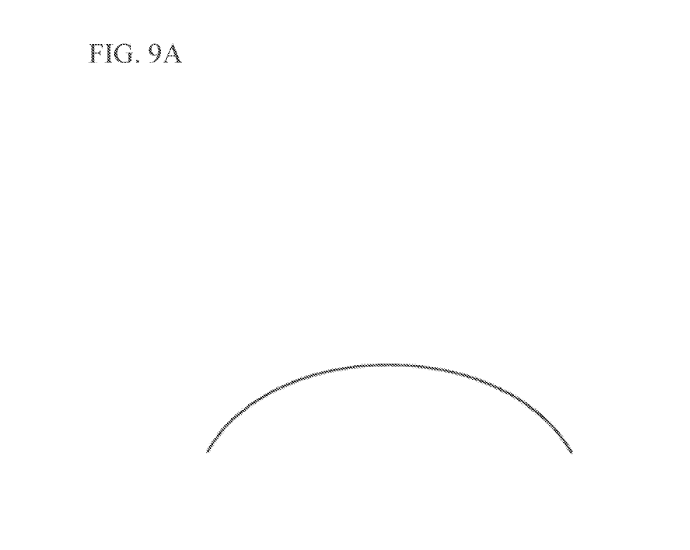

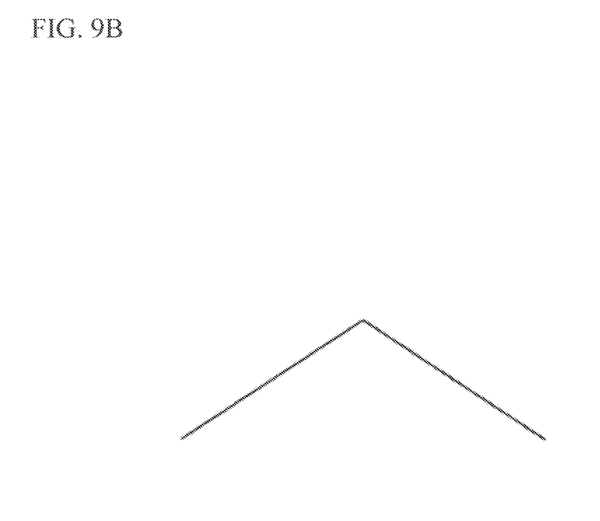

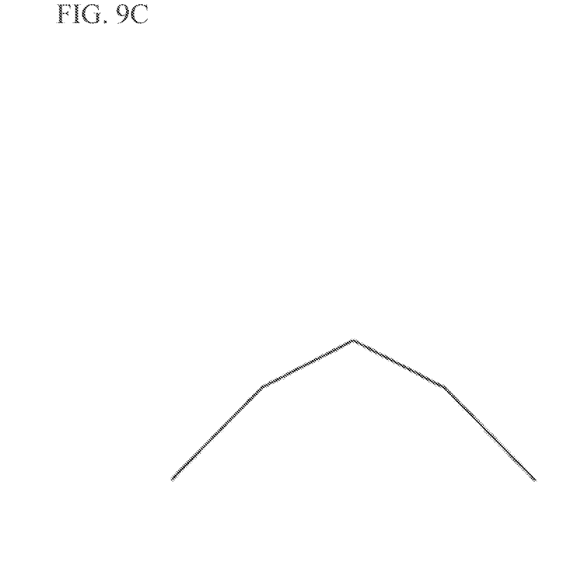

Although the cross-sectional shape of each prism in the lenticular portion 25 may be an arc shape as described above, the shape may change to a convex curve other than an arc, or a polygon such as a triangle or a pentagon as shown in FIGS. 9(a) through 9(c).

### Second Embodiment

Next, a second embodiment according to embodiments of the present invention is described. This embodiment describes an example where a lenticular portion is provided not only on the secondary emission surface, but also on the main emission surface along a direction perpendicular to the secondary incidence surface.

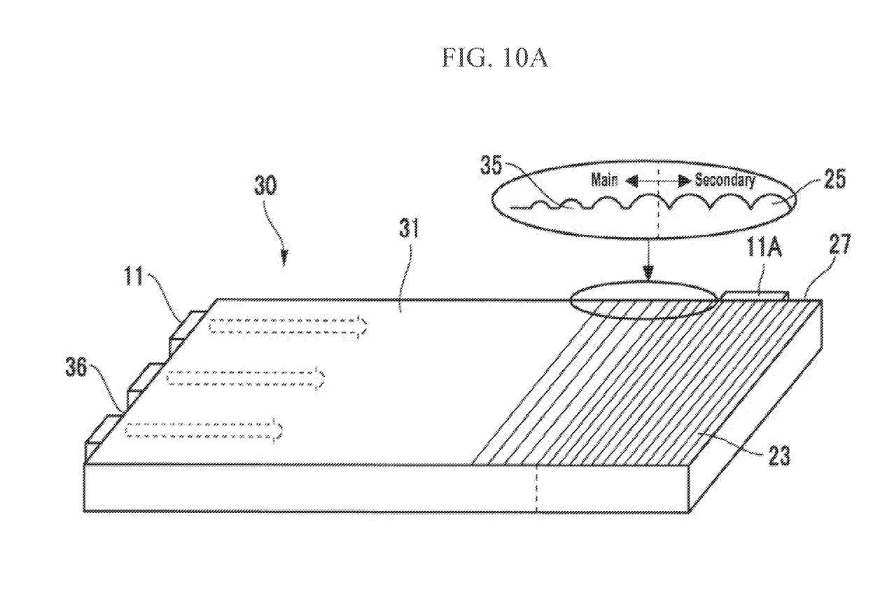

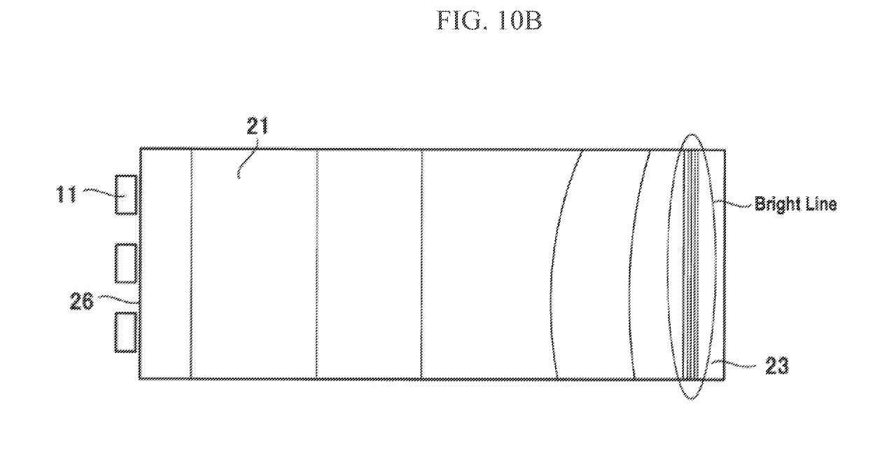

FIG. 10 is a perspective view illustrating a light guide plate 30 according to this embodiment. In this embodiment, the same reference numerals are used for identical configurations in FIG. 6 while omitting the descriptions, to thus mainly discuss here the configurations different from those in FIG. 6.

(Configuration of the Light Guide Plate 30)

FIG. 10(a) is a perspective view illustrating the light guide plate 30 according to this embodiment. The light guide plate 30 also has a substantially rectangular, flat plate in plan view. The light guide plate 30 includes a main incidence surface 36 whereon the light emitted from the main light source 11 is incident and a main emission surface 31 wherefrom the light entering through the main incidence surface 36 is emitted. The light guide plate 30 also includes a secondary incidence surface 37 whereon the light emitted from the secondary light source 11A is incident and a secondary emission surface 23 wherefrom the light entering through the secondary incidence surface 27 is emitted.

FIG. 10(b) shows the luminance distribution (simulation) of the emission light when the light guide plate 10 shown in FIG. 6 is used and the surface light source device 1 is activated. According to the light guide plate 10 shown in FIG. 6, the light emitted from the main light source 11 and entering through the main incidence surface 26 tends to impinge on the end of the lenticular portion 25 at the boundary portion between the main emission surface 21 and the secondary emission surface 23 and exit all at once from the main emission surface 21. Thus, as shown in FIG. 10(b), a bright line tends to appear at the boundary portion between the main light emission surface 21 and the secondary emission surface 23.

Whereas, in this embodiment, a lenticular portion 35 is provided also on the main emission surface 31 near the secondary emission surface 23 along a direction perpendicular to the secondary incidence surface 27. The lenticular portion 35 is configured such that the height and the width of the prism continuously decreases (that is, the prism per unit area decreases its area) along the direction from the boundary portion between the main emission surface 31 and the secondary emission surface 23 toward the main incidence surface 36. As such, a clear boundary portion between the main emission surface 31 and the secondary emission surface 23 can be eliminated. Further, the light emitted from the main light source 11 entering the light guide plate 30 through the main incidence surface 36 can be made to exit gradually from the main emission surface 31 via the lenticular portion 35 before reaching the boundary portion between the main emission surface 31 and the secondary emission surface 23.

Accordingly, the light emitted from the main light source 11 and entering the light guide plate 30 through the main incidence surface 36 is prevented from impinging on the lenticular portion 25 at the boundary portion between the main emission surface 31 and the secondary emission surface 23 and exiting all at once from the main emission surface 31. This prevents a bright line from appearing at the boundary portion between the main emission surface 31 and the secondary emission surface 23. The prism configuring the lenticular portion 35 in this embodiment corresponds to the first protrusions.

According to this embodiment, the prism configuring the lenticular portion 35 may also be configured such that the ratio of height to width of the prism decreases along the direction from the boundary portion between the main emission surface 31 and the secondary emission surface 23 toward the main emission surface 36. According to this configuration, it is possible to reduce the light scattering effect due to the prisms of the lenticular portion 35 along the direction from the boundary portion between the main emission surface 31 and the secondary emission surface 23 toward the main incidence surface 36. As a result, a clear boundary portion between the main emission surface 31 and the secondary emission surface 23 can be eliminated. Further, the light emitted from the main light source 11 entering the light guide plate 30 through the main incidence surface 36 can be made to exit gradually from the main emission surface 31 via the lenticular portion 35 before reaching the boundary portion between the main emission surface 31 and the secondary emission surface 23.

Further, the shape of the prism constituting the lenticular portion 35 may change gradually along the direction from the boundary portion between the main emission surface 31 and the secondary emission surface 23 to the main incidence surface 36. With these structures, the light emitted from the main light source 11 and entering the light guide plate 30 through the main incidence surface 36 may exit gradually from the main emission surface 31 by the lenticular portion 35 before reaching the boundary portion between the main emission surface 31 and the secondary emission surface 23

Further, according to this embodiment, the prism constituting the lenticular portion 35 and the prism constituting the lenticular portion 25 may have the same shape at the boundary portion between the main emission surface 31 and the secondary emission surface 23. This makes it possible to further reliably eliminate the clear boundary portion between the emission surface 31 and the secondary emission surface 23, thereby further reliably preventing a bright line from being seen at the boundary between the main emission surface 31 and the secondary emission surface 23.

### Third Embodiment

Next, a third embodiment according to the present invention is described. This embodiment discusses an example where a lenticular portion is provided on both the secondary emission surface and the main emission surface along a direction perpendicular to the secondary incidence surface, and a lenticular portion is further provided perpendicular to the main incidence surface on the main emission surface in a portion with no lenticular portion provided perpendicular to the secondary incidence surface. In this embodiment, the same reference numerals are used for identical configurations in the previous embodiment while omitting the corresponding descriptions to thus mainly discuss the configurations that are distinct from the previous embodiment.

(Configuration of Light Guide Plate 40)

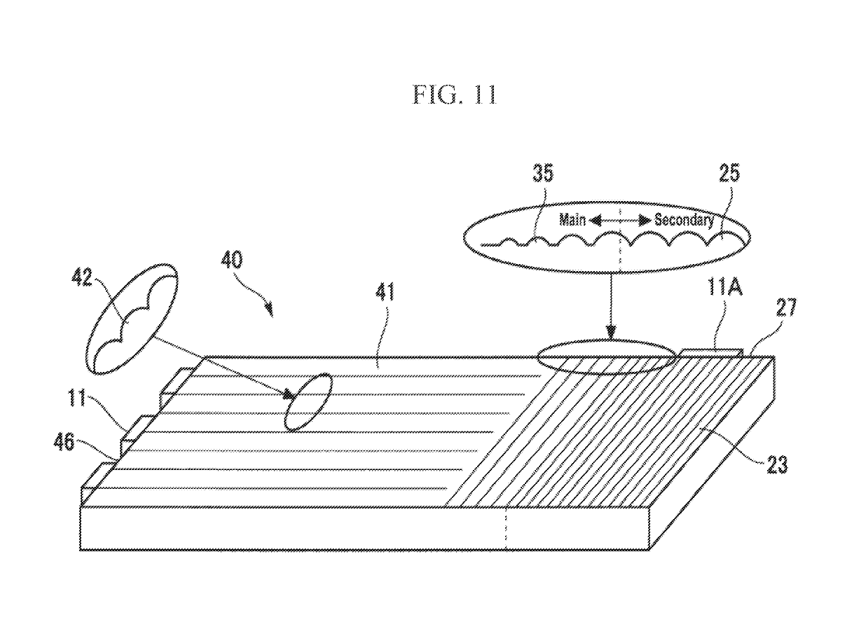

FIG. 11 is a perspective view illustrating a light guide plate 40 according to this embodiment. The light guide plate 40 has a substantially rectangular flat plate in plan view. The light guide plate 30 includes a main incidence surface 46 whereon the light emitted from the main light source 11 is incident and a main emission surface 41 wherefrom the light entering through the main incidence surface 46 is emitted.

Here, in this embodiment, the lenticular portion 35 perpendicular to the secondary incidence surface 27 is provided on the main emission surface 41 near the secondary emission surface 23. Similarly, as in the second embodiment, the lenticular portion 35 is configured such that the height and the width of the prism continuously decrease along the direction from the boundary portion between the main emission surface 41 and the secondary emission surface 23 toward the main incidence surface 46. Further, according to this embodiment, a lenticular portion 42 perpendicular to the main incidence surface 46 is provided on the main emission surface 41 in the region where the lenticular portion 35 is not provided. The lenticular portion 42 is configured such that the height and the width decrease with distance from the main incidence surface 46 (that is, the prism per unit area decreases its area) so that the lenticular portion 42 disappears before reaching the portion where the lenticular portion 35 is provided.

As such, as described in the second embodiment, it is possible to suppress a bright line caused by light exiting from the main emission surface 41 all at once; more specifically, it is possible to suppress light from the main light source 11 entering the light guide plate 40 through the main incidence surface 46, impinging on the lenticular portion 25 at the boundary portion between the main emission surface 41 and the secondary emission surface 23 and exiting all at once from the main emission surface 41. In addition, the lenticular portion 42 prevents the light emitted from the main light source 11 and entering through the main incidence surface 46 from diffusing in a direction parallel to the main incidence surface 46; consequently, the lenticular portion 42 can direct more light toward the secondary emission surface 23. As a result, it is possible to increase luminance both on the main emission surface 41 and the secondary emission surface 23.

The lenticular portion 42 extends in a direction perpendicular to the main incidence surface 46 from the main incidence surface 46 on the main emission surface 41 and disappears before reaching the portion where the lenticular portion 35 is provided, and thus it is possible to avoid appearance of a bright line at the boundary portion between the area where the lenticular portion 42 is provided and the area where the lenticular portion 35 is provided. The prism constituting the lenticular portion 42 according to this embodiment corresponds to the third protrusions.

### Fourth Embodiment

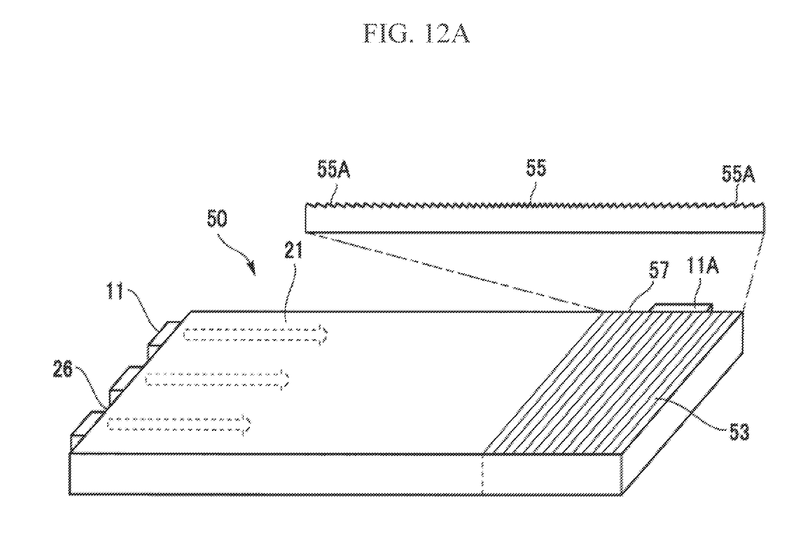

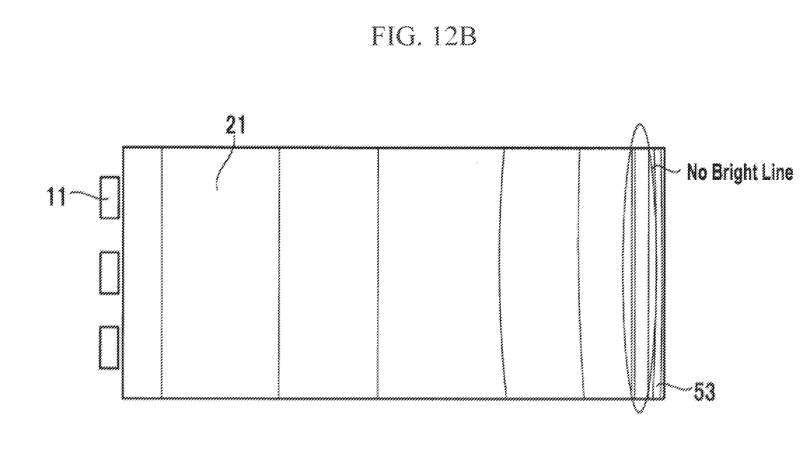

Next, a fourth embodiment according to the present invention is described with reference to FIG. 12. This embodiment discusses an example where a lenticular portion is provided on the secondary emission surface along a direction perpendicular to the secondary incidence surface; furthermore, the lenticular portion is configured so that when the light emitted from the main light source enters through the main incidence surface, the incidence angle of the light relative to the slope of the lenticular portion facing the main incidence surface gradually decreases with distance from the main incidence surface when viewed inside each prism, in a cross-sectional view of the lenticular lens when viewed along a line normal to the secondary incidence surface.

Also in this embodiment, the same reference numerals are used for identical configurations in the previous embodiment while omitting the descriptions, to thus mainly discuss the configurations different from the previous embodiment.

(Configuration of Light Guide Plate 50)

FIG. 12(a) shows a perspective view of a light guide plate 50 according to this embodiment. The light guide plate 50 has a substantially rectangular flat plate in plan view. The light guide plate 50 includes a main incidence surface 26 whereon the light emitted from the main light source 11 is incident and a main emission surface 21 wherefrom the light entering through the main incidence surface 26 is emitted. Further, the light guide plate 50 includes a secondary incidence surface 57 whereon the light emitted from the secondary light source 11A is incident and a secondary emission surface 53 wherefrom the light entering through the secondary incidence surface 57 is emitted.

According to this embodiment, the main emission surface is formed as a mirror surface. A lenticular portion 55 is provided on a secondary emission surface 53 extending along a direction perpendicular to a secondary incidence surface 57. The cross-sectional shape of each prism in the lenticular portion 55 viewed from a direction normal to the secondary incidence surface 57 does not change and maintains a constant shape along a direction perpendicular to the secondary incidence surface 57. Whereas, along a direction parallel to the secondary incidence surface 57, for the prisms provided closer to the main incidence surface 26 than the center of the secondary emission surface 53, an angle of incidence of the light traveling in a direction normal to the main incidence surface 26 relative to a slope 55A facing the main incidence surface 26 gradually decreases with distance from the main incidence surface 26 when viewed from inside the prisms.

Thereby, the light entering the light guide plate 50 through the main incidence surface 26 reaches the secondary emission surface 53 while some amount of light is emitted through the main emission surface 21. The large incidence angle of the light relative to the prisms tends to cause total reflection on the lenticular portion 55 in the area of the secondary emission surface 53 near the main light incidence surface 26, thereby reducing the amount of light emitted to the outside through the secondary emission surface 53. The light incidence angle relative to each prism of the lenticular portion 55 decreases with distance from the main incidence surface 26 on the secondary emission surface 53; light is thus more likely to pass through the secondary emission surface 53, and the secondary emission surface 53 emits more light to the outside.

Accordingly, it is possible to prevent a drastic increase in emission of the light from the main incidence surface 26 reaching the prisms of the lenticular portion 55 from drastically increasing near the boundary between the main emission surface 21 and the secondary emission surface 53. As a result, the bright line is prevented from appearing in the boundary portion between the main emission surface 21 and the secondary emission surface 53.

Here, FIG. 12(b) shows an example of a simulation result for luminance distribution when the main light source 11 is turned on and the secondary light source 11A is turned off in the light guide plate 50 according to this embodiment. According to this simulation, it can be recognized that a bright line does not appear as in FIG. 10 even in the boundary region between the main emission surface 21 and the secondary emission surface 53.

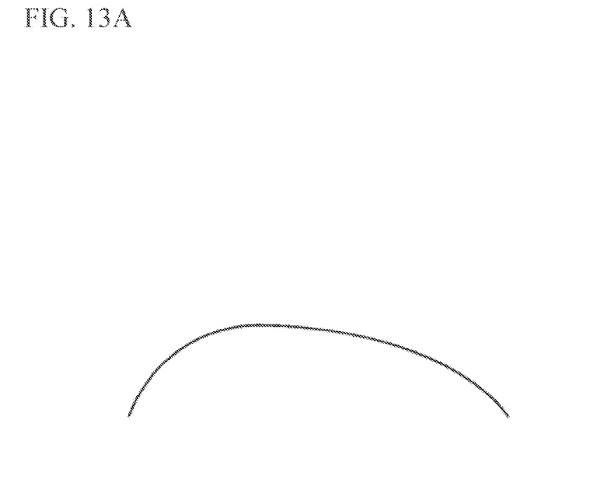

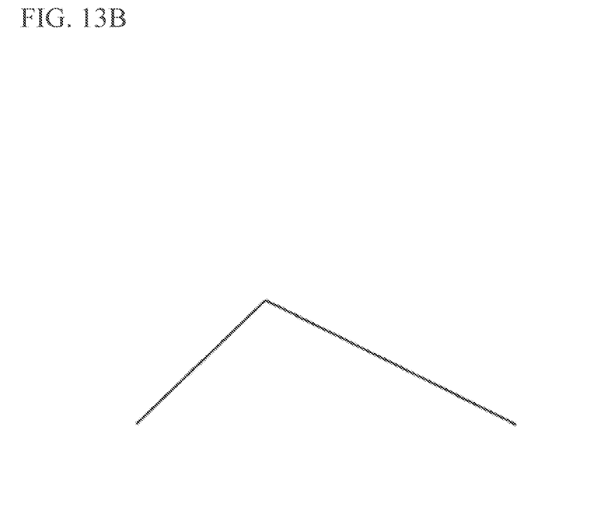

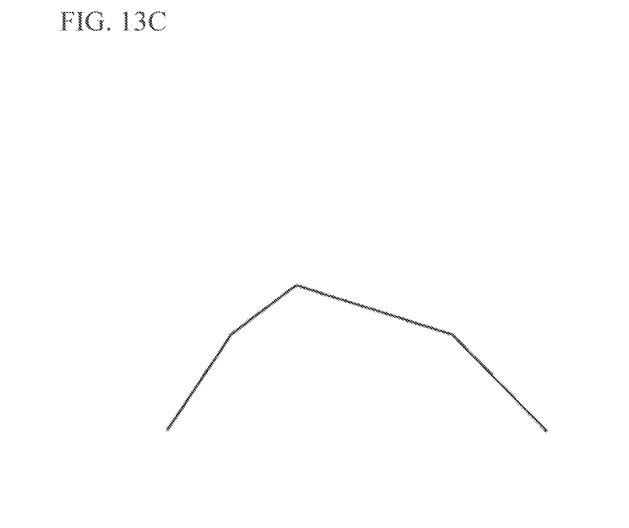

The cross-sectional shape of the lenticular portion 55 has different variations. As shown in FIGS. 13(a) through 13(c), such variations may include a shape of an eccentric convex curvature, or a polygon such as an eccentric triangle, an eccentric pentagon and so forth. The light incidence angle relative to the slope 55A facing the main incident surface 26 when viewed from the inside of prisms for the light traveling in a direction normal to the main incidence surface 26 corresponds to “an acute angle formed between a line normal to the first incidence surface and a slope facing the first incidence surface when viewed from the inside of the light guide plate.”

Further, in this embodiment, for the prisms provided closer to the main incidence surface 26 than the center of the secondary emission surface 53, the incidence angle relative to the slope 55A facing the main incidence surface 26 when viewed from the inside of the prisms for the light traveling in a direction normal to the main incidence surface 26 may be made smaller than the incidence angle relative to the slope facing opposite the main incidence surface 26 when viewed from the inside of the prisms. This may also suppress the appearance of a bright line caused by light from the main light source 11 entering through the main incidence surface 26 directly reaching the prisms of the lenticular portion 55 and exiting therefrom all at once; consequently, the uniformity of the luminance distribution over the entire light guide plate improves. In this case, the light incidence angle relative to the slope facing opposite the main incident surface 26 when viewed from inside the prisms for the light traveling in a direction normal to the main incidence surface 26 corresponds to “an acute angle between a line normal to the first incidence surface and the slope facing opposite the first incidence surface when viewed from the inside of the light guide plate.”

### Fifth Embodiment

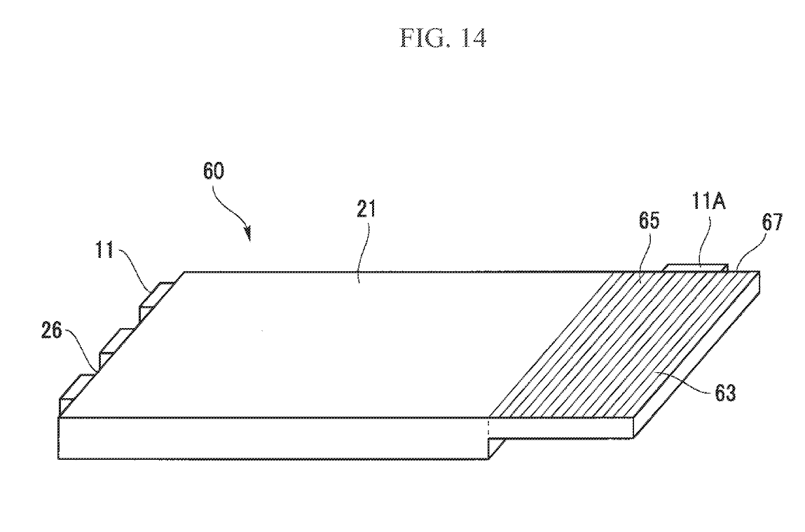

Next, a fifth embodiment according to the present invention is described with reference to FIG. 14. This embodiment discusses an example where a lenticular portion is provided extending in a direction perpendicular to the secondary incidence surface on the secondary emission surface of the light guide plate, while the thickness of the portion where the secondary emission surface is provided in the light guide plate is made less than the thickness of the portion where the main emission surface is provided in the light guide plate.

In this embodiment, the same reference numerals are used for identical configurations in the previous embodiment while omitting the descriptions, to thus mainly discuss the configurations different from the previous embodiment.

(Configuration of Light Guide Plate 60)

FIG. 14 is a perspective view of a light guide plate 60 according to this embodiment. The light guide plate 60 has a substantially rectangular flat plate in plan view. The light guide plate 60 includes a main incidence surface 26 whereon the light emitted from the main light source 11 is incident and a main emission surface 21 wherefrom the light entering through the main incidence surface 26 is emitted. Further, the light guide plate 60 includes a secondary incidence surface 67 whereon the light emitted from the secondary light source 11A is incident and a secondary emission surface 63 wherefrom the light entering through the secondary incidence surface 67 is emitted.

A lenticular portion 65 is provided extending in a direction perpendicular to the secondary incidence surface on the secondary emission surface 63 of the light guide plate 60. The lenticular portion 65 according to this embodiment is equivalent to that in the first embodiment. According to this embodiment, the thickness of the portion where the secondary emission surface 63 is provided in the light guide plate 60 is made less than the thickness of the portion where the main emission surface 21 is provided in the light guide plate 60.

According to this embodiment, the thickness of the portion where the secondary emission surface 63 is provided in the light guide plate 60 is made less, thereby relatively increasing the likelihood that the light entering the light guide plate 60 through the secondary incidence surface 67 is incident on the lenticular portion 65. Thereby, the lenticular portion 65 serves to increase the effect of confining light in the light guide plate 60, thereby decreasing the amount of light leaking out to the main emission surface 21. Accordingly, it is possible to more reliably prevent the light incident on the secondary incidence surface 67 from the secondary light source 11A from leaking out to the main emission surface 21 and being emitted therefrom, and thus the unevenness in luminance can be suppressed over the entire light guide plate 60.

### Sixth Embodiment

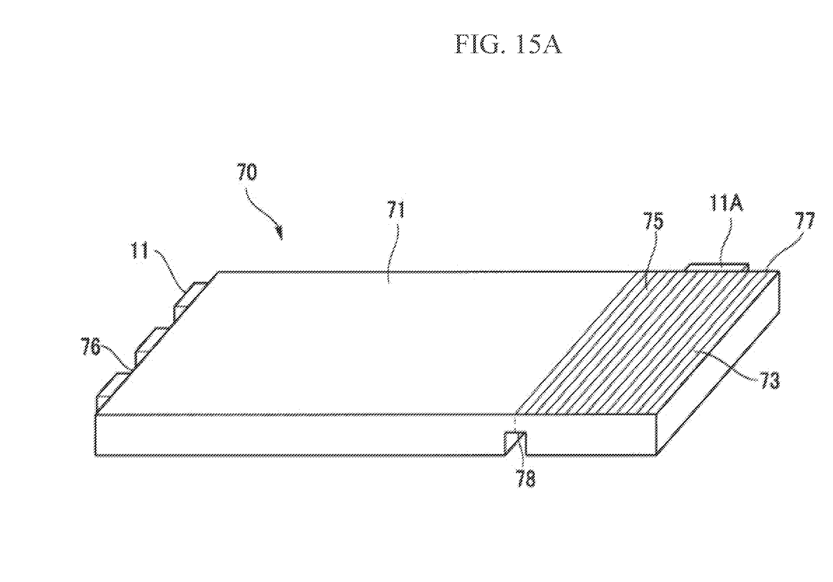

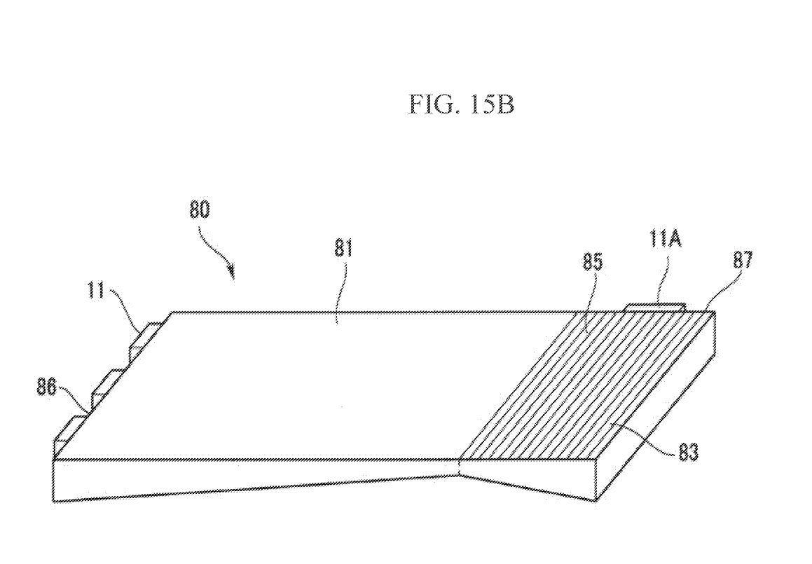

Next, a sixth embodiment according to the present invention is described with reference to FIG. 15. This embodiment discusses an example where a lenticular portion is provided on the secondary emission surface of the light guide plate, which extends in a direction perpendicular to the secondary incidence surface, while the thickness of the light guide plate is made less at a boundary portion between the main emission surface and the secondary emission surface.

FIG. 15 is a perspective view of a light guide plate 70 and a light guide plate 80 according to this embodiment. In this embodiment shown in FIG. 15, the same reference numerals are used for identical configurations in the previous embodiment while omitting the descriptions, to thus mainly discuss the configurations different from the previous embodiment.

(Configuration of Light Guide Plates 70 and 80)

Referring to FIG. 15(a), the light guide plate 70 has a substantially rectangular flat plate shape in plan view. The light guide plate 70 includes a main incidence surface 76 whereon the light emitted from the main light source 11 is incident and a main emission surface 71 wherefrom the light entering through the main incidence surface 76 is emitted. The light guide plate 70 also includes a secondary incidence surface 77 whereon the light emitted from the secondary light source 11A is incident and a secondary emission surface 73 wherefrom the light entering through the secondary incidence surface 77 is emitted.

A lenticular portion 75 is provided on the secondary emission surface 73 of the light guide plate 70 according to this embodiment. The lenticular portion 75 according to this embodiment is equivalent to that in the first embodiment. According to this embodiment, although the thickness of the portion where the secondary emission surface 73 is provided is equivalent to the thickness of the portion where the main emission surface 71 is provided, a recessed groove 78 is formed on a rear surface 72 at the boundary portion therebetween, and thus the thickness of the boundary portion of the light guide plate 70 is made less than the thickness of other portions.

According to this embodiment, the cross-sectional area of the light guide plate 70 decreases at the boundary between the portion where the secondary emission surface 73 is provided and the portion where the main emission surface 71 is provided in the light guide plate 70, while the ratio of the thickness of the lenticular portion 75 relatively increases. Thereby, according to this embodiment, the light emitted from the secondary light source 11A entering the light guide plate 70 through the secondary incidence surface 77 is prevented from leaking out to the main emission surface 71. Accordingly, the lenticular portion 75 traps light more effectively, thereby reducing the amount of light leaking out to the main emission surface 71. As a result, it is possible to more reliably prevent the light from the secondary light source 11A entering through the secondary incidence surface 77 from leaking out to the main emission surface 71 from the secondary emission surface 73 and being emitted therefrom, and thus the unevenness in luminance can be suppressed over the entire light guide plate 70.

Similarly, FIG. 15(b) shows another example according to this embodiment. Referring to FIG. 15(b), the light guide plate 80 has a substantially rectangular flat plate in plan view. The light guide plate 80 includes a main incidence surface 86 whereon the light emitted from the main light source 11 is incident and a main emission surface 81 wherefrom the light entering through the main incidence surface 86 is emitted. The light guide plate 80 also includes a secondary incidence surface 87 whereon the light emitted from the secondary light source 11A is incident and a secondary emission surface 83 wherefrom the light entering through the secondary incidence surface 87 is emitted.

A lenticular portion 85 is provided on the secondary emission surface 83 of the light guide plate 80 according to this embodiment. The lenticular portion 85 according to this embodiment is equivalent to that in the first embodiment. According to this embodiment, the thickness of the portion where the secondary emission surface 83 is provided and the thickness of the portion where the main emission surface 81 is provided are equal to each other at both ends along the long side of the light guide plate 80. The thickness of the light guide plate 80 linearly decreases from both sides of the light guide plate 80 toward the boundary portion between the portion where the secondary emission surface 83 is provided and the portion where the main emission surface 81 is provided. The light guide plate 80 has the minimum thickness at the boundary portion.

The thickness of the light guide plate 80 decreases and the ratio of the thickness of the lenticular portion 85 relatively increases at the boundary between the portion where the secondary emission surface 83 is provided and the portion where the emission surface 81 is provided. Accordingly, the lenticular portion 85 serves to increase the effect of confining light, thereby preventing the light emitted from the secondary light source 11A entering the light guide plate 80 through the secondary incidence surface 87 from leaking out to the main emission surface 81. Thus, the amount of light leaking toward the main emission surface 81 can be reduced. As a result, it is possible to more reliably prevent the light from the secondary light source 11A entering through the secondary incidence surface 87 from leaking out to the main emission surface 81 from the secondary emission surface 83 and being emitted therefrom, and thus the unevenness in luminance can be suppressed over the entire light guide plate 80.

### Seventh Embodiment

Next, a seventh embodiment according to the present invention is described. This embodiment will discuss an example where a lenticular portion is provided on the secondary emission surface of the light guide plate extending in a direction perpendicular to the secondary incidence surface while the width of portion where the secondary emission surface is provided in the light guide plate is narrower than the width of the portion where the main emission surface is provided.

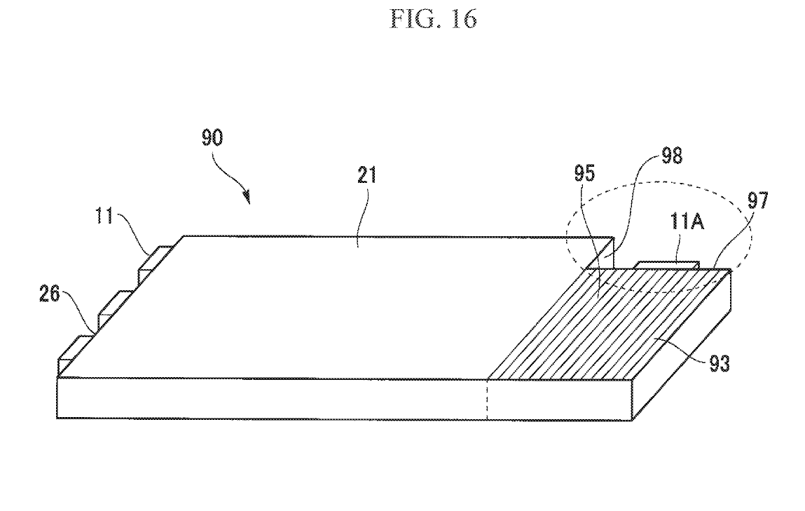

FIG. 16 is a perspective view of a light guide plate 90 according to this embodiment. In this embodiment as shown in FIG. 16, the same reference numerals are used for identical configurations in the previous embodiment while omitting the descriptions, to thus mainly discuss the configurations different from the previous embodiment.

(Configuration of Light Guide Plate 90)

Referring to FIG. 16, the light guide plate 90 has a substantially rectangular flat plate in plan view. The light guide plate 90 includes a main incidence surface 26 whereon the light emitted from the main light source 11 is incident and a main emission surface 21 wherefrom the light entering through the main incidence surface 26 is emitted. The light guide plate 90 also includes a secondary incidence surface 97 whereon the light emitted from the secondary light source 11A is incident and a secondary emission surface 93 wherefrom the light entering through the secondary incidence surface 97 is emitted.

A lenticular portion 95 is provided on the secondary emission surface 93 of the light guide plate 90 according to this embodiment. The lenticular portion 95 according to this embodiment is equivalent to lenticular portion in the first embodiment. According to this embodiment, the width in a direction perpendicular to the secondary incidence surface 97 of the portion where the secondary emission surface 93 is provided is narrower than the width of the portion where the main emission surface 21 is provided in the light guide plate 90, and a step 98 is formed at the boundary between the portion where the secondary emission surface 93 is provided and the portion where the main emission surface 21 is provided in the light guide plate 90. The secondary light source 11A is arranged in a space created by the step.

According to this embodiment, the width of the secondary emission surface 93 of the light guide plate 90 along a direction perpendicular to the secondary incidence surface 97 is narrower than the width of the portion where the main emission surface 21 is provided, and a space created by this configuration can be used to store the secondary light source 11A. This prevents the secondary light source 11A from protruding outside the profile of the light guide plate 90. As a result, providing a more efficient use of the space in the entire surface light source device 1. Further, other components such as a camera may be arranged in the space described above, and thus allowing for more efficient use of in the surface light source device 1 or the entire liquid crystal display device.

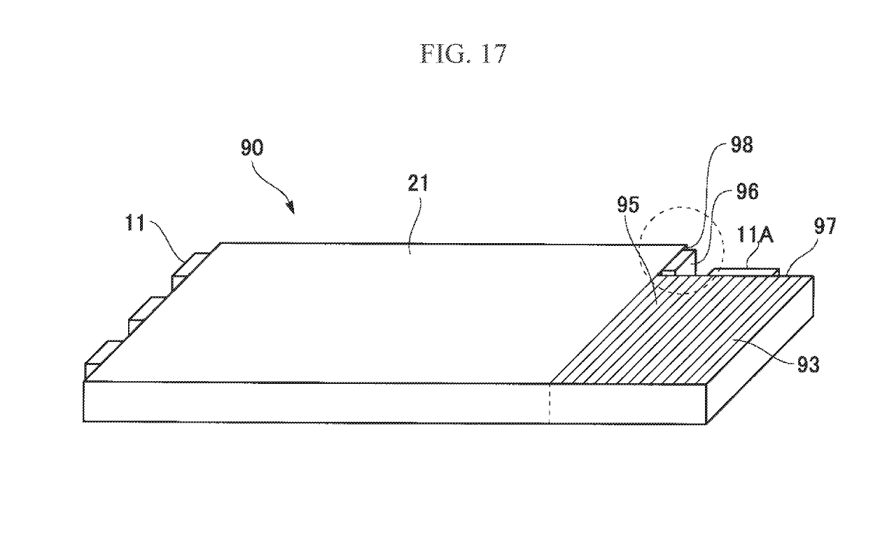

In addition, as shown in FIG. 17, a light shielding part 96 may be arranged on the surface of the step 98 made between the main emission surface and the secondary emission surface. According to this configuration, a portion of the light emitted from the secondary light source 11A is prevented from directly entering the light guide plate through the surface of the step 98 and into the portion of the light guide plate 90 forming the main emission surface. As a result, the luminance over the entire light guide plate 90 may be made more uniform.

According to this embodiment, the end face of the light guide plate 90 whereon the secondary incidence surface 97 is provided at the secondary emission surface 93 is recessed relative to the end face adjacent to the secondary incidence surface 97 near the main emission surface 21 while creating the step 98, which allows the secondary light source 11A to be stored in a space formed by the above-described recess. However, the step 98 is not necessarily required in this embodiment. For example, a slope may be formed between the end face of the light guide plate 90 forming the secondary incidence surface 97 and the end face adjacent to the secondary incidence surface 97 at the portion where the main emission surface 21 is provided. In this case, the light blocking part 96 may be provided on the slope.

According to the light guide plates described in the first through seventh embodiments, the light entering through a secondary incidence surface from a secondary light source is prevented from leaking toward a main emission surface, which, as a result, can improve uniformity of luminance over the entire light guide plate, thereby suppressing the unevenness in luminance. Accordingly, it is possible to provide a dual-screen liquid crystal display device that has high uniformity of luminance by mounting, as a backlight, a surface light source device equipped with such a light guide plate.

In addition, such a display device can be mounted on various types of electronic devices. Electronic devices equipped with such a display device include a smartphone, a digital camera, a tablet terminal, an electronic book, a wearable device, a car navigation device, an electronic dictionary, an electronic billboard or the like. These electronic devices have excellent luminance uniformity, and are expected to provide higher-quality display performance.

Further, according to the embodiments described above, dot patterns may be formed on at least one of a main emission surface, a secondary light emission surface, or a rear surface thereof for scattering light guided through a light guide plate. These dot patterns allow the first emission surface or the second emission surface to emit light more efficiently.

According to the embodiments described above, dot patterns are provided on a main emission surface or a rear surface opposite the main emission surface; the dot patterns per unit area may reach its maximum area at an arbitrary point from the main incidence surface to a boundary between the main emission surface and a secondary emission surface; and the dot patterns per unit area at the boundary may be less than the maximum value. According to the embodiments, the main emission surface may emit light from a main light source entering through the main incidence surface more efficiently. This more reliably prevents light from the main light source entering through the main incidence surface from being viewed as a bright line, since the bright line is due to light directly reaching a lenticular portion on the secondary emission surface and exiting therefrom all at once. Thereby, it is possible to improve the uniformity of the luminance distribution over the entire light guide plate.

According to the embodiments described above, at least a part of prisms constituting each lenticular portion may be provided periodically along the extending direction. According to this configuration, the light entering through each incidence surface may be prevented from diffusing toward a direction perpendicular to the traveling direction while allowing the intermittently provided prisms to serve as dot patterns. This allows the light guide plate to emit light more efficiently. As a result, the light entering through the secondary incidence surface is more reliably prevented from leaking out of the secondary emission surface side toward the main emission surface side, while it is possible to increase the uniformity of luminance over the light guide plate and suppress the unevenness in luminance.

The above-described embodiments discuss examples of cases where all lenticular structures (first protrusions, second protrusions, third protrusions) are provided on the emission surface of a light guide plate. However, all the lenticular structures described above may be provided on a rear surface opposite the emission surface of the light guide plate. This configuration also makes it possible to obtain an effect equivalent to the above-described embodiments. The lenticular structures are provided over the entire secondary emission surface in the above-described embodiments. However, the lenticular structures are not necessarily provided over the entire secondary emission surface. For example, the lenticular structures may be provided on a part of the secondary emission surface side. The lenticular structures are not necessarily constituted by convex shaped prisms, and may be constituted by concave shaped prisms.

Further in the above-described embodiments, when defining a direction, the direction is defined by depicting “parallel to” or “perpendicular to” a certain surface (for example, a main incidence surface, a secondary incidence surface, etc.) These depictions do not necessarily imply having exact 90 degrees or 180 degrees, and allow for a change if the change falls within the allowable range for obtaining the equivalent effect. For example, a change up to ±5 degrees is sufficiently acceptable for both parallel and perpendicular directions.

According to the above-described embodiments, although the main light source and the secondary light source are arranged on the side surfaces of a light guide plate, these light sources are not necessarily arranged to face the end faces from the outside. For example, the main light source or the secondary light source may be arranged on the side surface in a hole for a light source made near the end face of the light guide plate.

### DESCRIPTION OF THE REFERENCE NUMERALS

1 Surface light source device
2 Liquid crystal panel
10, 30, 40, 50, 60, 70, 80, 90 Light guide plate
11 Main light source
11A Secondary light source
12 Flexible printed circuit board
13 Frame
14 Fixing part
15 Reflective sheet
16 Diffusion sheet
17A, 17B Prism sheet
18 Light shielding double-sided tape
21, 31, 41, 71, 81 Main emission surface
23, 53, 63, 73, 83, 93 Secondary emission surface
25, 35, 42, 55, 65 Lenticular portion
26, 36, 76, 86 Main incidence surface
27, 57, 67, 77, 87, 97 Secondary incidence surface
98 Step

1. A light guide plate comprising:
a first incidence surface whereon light from a first light source is incident;
a first emission surface intersecting with the first incidence surface in a direction substantially perpendicular thereto for emitting the light entering through the first light incident surface;
a second incidence surface whereon light from a second light source is incident; and
a second emission surface intersecting with the second incidence surface in a direction substantially perpendicular thereto for emitting the light entering through the second incidence surface, wherein
the light guide is substantially planar;
the first incidence surface and the second incidence surface are provided on side surfaces along directions substantially perpendicular to each other;
the first emission surface and the second emission surface are provided in different regions in the same plane on a first surface; and
a pattern is formed extending in a direction substantially perpendicular to the second incidence surface on at least one of the second emission surface and a region corresponding to the second emission surface on a second surface opposite the first surface.

2. The light guide plate according to claim 1, wherein the pattern is made up of a plurality of second protrusions extending in a direction substantially perpendicular to the second incidence surface.

3. The light guide plate according to claim 2, wherein
the second incidence surface is provided in a part of a region opposite the first incidence surface on a side surface where the second incidence surface is provided;
the second emission surface is provided on the first surface whereon the second emission surface and the first emission surface are provided in a part of the region opposite the first incidence surface;
the first emission surface is provided in a region on the first surface excluding the second emission surface; and
a plurality of first protrusions is provided continuously from the plurality of second protrusions extending in a direction substantially perpendicular to the second incidence surface in at least one of a portion near the second protrusions on the first emission surface and the region corresponding to the first emission surface on the second surface.

4. The light guide plate according to claim 3, wherein the percentage area of the first protrusions per unit area decreases with distance from the second protrusions in a portion where the plurality of first protrusions are provided.

5. The light guide plate according to claim 3, wherein a ratio of height to width of the first protrusions decreases with distance from the second protrusions in a portion where the plurality of first protrusions are provided.

6. The light guide plate according to claim 4, wherein the shape of the first protrusions gradually changes with distance from the second protrusions in a portion where the plurality of first protrusions are provided.

7. The light guide plate according to claim 3, wherein the first protrusions and the second protrusions have substantially the same shape at a boundary therebetween.

8. The light guide plate according to claim 3, wherein at least a portion of the surface whereon no first protrusions are provided is a mirror surface in a region where the first protrusions are provided among the first emission surface and the region corresponding to the first emission surface on the second surface.

9. The light guide plate according to claim 3, further comprising: third protrusions; the third protrusions extending in a direction substantially perpendicular to the first incidence surface and provided in a portion having no first protrusions in the region including the plurality of first protrusions among the first emission surface and the region corresponding to the first emission surface on the second surface; and the percentage area of the third protrusions per unit area decreases as the distance thereof from the first incidence surface increases.

10. The light guide plate according to claim 2, wherein the cross-sectional shape of the second protrusions viewed along the extending direction is an arc, a convex curve, a triangle, a rectangle or larger-sided polygon.

11. The light guide plate according to claim 2, wherein when viewing a cross section of the second protrusions along the extending direction thereof in a section closer to the first incidence surface than the center of the part whereon the second protrusions are provided, an acute angle between a line normal to the first incidence surface and a slope of the second protrusions oriented toward the first incidence surface when viewed from the inside the light guide plate increases with distance from the first incidence surface.

12. The light guide plate according to claim 2, wherein when viewing a cross section of the second protrusions along the extending direction thereof in a section closer to the first incidence surface than the center of the part whereon the second protrusions are provided, an acute angle between a line normal to the first incidence surface and a slope of the second protrusions oriented toward the first incidence surface when viewed from the inside of the light guide plate is smaller than an acute angle between a line normal to the first incidence surface and a slope of the second protrusions oriented away from the first incidence surface when viewed from the inside of the light guide plate as the second protrusions approach the first incidence surface.

13. The light guide plate according to claim 2, wherein the ratio of height to width of the second protrusions is greater than or equal to 0.067.

14. The light guide plate according to claim 2, wherein the ratio of height to width of the second protrusions is greater than or equal to 0.158.

15. The light guide plate according to claim 2, wherein the width of the second emission surface along a direction parallel to the first incidence surface is narrower than the width of the first emission surface along a direction parallel to the first light incident surface, and the end face whereon the second incidence surface is provided is recessed relative to the end face adjacent to the second incidence surface near the first emission surface.

16. The light guide plate according to claim 15, wherein
the end face whereon the second incidence surface is provided is recessed relative to the end face adjacent to the second incidence surface near the first emission surface and creates a step; and
the step is provided with a light shielding part configured to prevent light from the second light source from entering the light guide plate through the step.

17. The light guide plate according to claim 2, wherein the second emission surface is thinner than the first emission surface.

18. The light guide plate according to claim 2, wherein a boundary portion between the first emission surface and the second emission surface is thinner than other regions.

19. The light guide plate according to claim 2, wherein dot patterns for scattering the light guided through the light guide plate are provided on at least one of the first surface whereon the first emission surface and the second emission surface are provided and the second surface.

20. The light guide plate according to claim 2, wherein dot patterns are provided on at least one of the first emission surface and the region corresponding to the first emission surface on the second surface, and in plan view the dot patterns are at the maximum per unit area in a prescribed portion from the first incidence surface to a boundary portion between the first emission surface and the second emission surface.

21. The light guide plate according to claim 2, wherein the second protrusions are provided periodically along the extending direction.

22. A surface light source device comprising:
a light guide plate according to claim 1;
light sources arranged facing the incidence surfaces of the light guide plate; and
a frame configured to surround the side surfaces of the light guide plate.

23. A display device comprising:
a surface light source device according to claim 22; and
a display panel that receives light emitted from the surface light source device.

24. An electronic device, wherein
the electronic device is provided with a display device according to claim 23.
